(19) United States
(12) Patent Application Publication
(10) Pub. No.: US 2023/0045470 A1
(43) Pub. Date: Feb. 9, 2023

(54) GUIDING DEVICE OF A SYSTEM FOR CONFINING AND COOLING MELT FROM THE CORE OF A NUCLEAR REACTOR

(71) Applicants: JOINT-STOCK COMPANY "ATOMENERGOPROEKT", Moscow (RU); SCIENCE AND INNOVATIONS - NUCLEAR INDUSTRY SCIENTICFIC DEVELOPMENT, PRIVATE ENTERPRISE, Moscow (RU)

(72) Inventors: ALEKSANDR STALEVICH SIDOROV, Moscow (RU); TATYANA YAROPOLKOVA DBANDOVSKAYA, Moscow (RU); NADEZHDA VASILIEVNA SIDOROVA, Moscow (RU)

(73) Assignees: JOINT-STOCK COMPANY "ATOMENERGOPROEKT", Moscow (RU); SCIENCE AND INNOVATIONS - NUCLEAR INDUSTRY SCIENTICFIC DEVELOPMENT, PRIVATE ENTERPRISE, Moscow (RU)

(21) Appl. No.: 17/619,121

(22) PCT Filed: Dec. 29, 2020
(86) PCT No.: PCT/US2020/000763

§ 371 Date: Dec. 14, 2021

(30) Foreign Application Priority Data
Mar. 18, 2020 (RU) 2020111301

(51) Int. Cl. G21C 13/10; G21C 9/016

(52) U.S. Cl. CPC G21C 13/10; G21C 9/016

(57) ABSTRACT

The invention is applicable to the corium localizing and cooling systems of a nuclear reactor designed for localization of severe beyond design-basis accidents, in particular, to the devices for directing corium of a nuclear reactor to the corium trap.

The technical result of the claimed invention is to increase the efficiency of localization and cooling of the nuclear reactor core melt.

The goal of the invention is to eliminate the guide assembly failure due to the concentration of impact load in the conical part of the guide assembly and, therefore, the instantaneous penetration of the core, fragments of the reactor vessel internals and the reactor vessel head into the core catcher.

In accordance with the invention, the guide assembly of the corium localizing and cooling system installed under the reactor pressure vessel and resting on the cantilever truss apart from the load-bearing frame contains the thermal elements that in the aggregate allows providing guaranteed entry of core, debris of the internals and the head of the reactor pressure vessel into the corium trap by excluding melt-through of the walls of conical and cylindrical parts and by redistributing the corium jet streams.

### TECHNICAL FIELD OF THE INVENTION

The invention is applicable to the corium localizing and cooling systems of a nuclear reactor designed for localization of severe beyond design-basis accidents, in particular, to the devices for directing corium of a nuclear reactor to the corium trap.

The accidents with core meltdown, which may take place during multiple failure of the core cooling system, constitute the greatest radiation hazard.

During such accidents the core melt—corium—by melting the core structures and reactor pressure vessel, flows out beyond its limits, and as a consequence of the decay heat retained in it may disturb the NPP containment integrity—the last barrier on the escape routes of radioactive products to the environment.

It is required to localize corium escaping from the reactor pressure vessel for excluding this, and provide its continuous cooling up to complete crystallization of all the corium components. The corium trap performs this function, which after entry of corium into it prevents the NPP containment damage, thereby protecting the public and environment against radiation impact during severe accidents of the nuclear reactors by cooling and subsequent crystallization of corium.

After the reactor vessel rupture corium enters the guide assembly, which is usually executed in funnel shape installed on the cantilever truss, and designed for changing the corium movement direction from the place of its escape from the reactor pressure vessel towards the reactor cavity axis for guaranteed input of corium to the maintenance platform. By burning the service platform, corium enters into the corium trap, where it enters into interaction with the filler by gradually heating the corium trap casing. In addition, during the melt-through of the reactor pressure vessel, the head of the reactor pressure vessel may completely separate following which the head of the reactor pressure vessel falls on the guide assembly, considerably reducing or completely blocking the entry of corium into the corium trap. This may lead to accumulation of corium in the guide assembly area, increase of corium temperature, burning through of the dry protection base and surrounding structural concrete, collapse of dry protection into corium, chemical interaction of serpentine concrete of dry protection with corium with generation of a large quantity of hydrogen, other non-condensing gases and aerosols. The generation of large quantity of hydrogen, other non-condensing gases and aerosols shall lead to considerable increase of the risks of hydrogen explosions and above design pressure buildup in the containment which consequently may lead to containment damage and escape of beyond design quantity of radioactive fission products outside the containment.

### PRIOR ART

The guide assembly [1] (RF Patent No. 2253914, priority dated 18 Aug. 2003) of the nuclear reactor corium localizing and cooling system installed below the reactor pressure vessel head and resting on the cantilever truss executed in funnel form comprising of the cylindrical and conical parts, surfaces thereof are covered with heat-resistant concrete, apertures made in the center of the conical part is well-known.

One disadvantage of the guide assembly is the insufficient heat insulation of the walls of conical and cylindrical parts. In the event of quick entry of corium from the reactor pressure vessel on separation of the head with full cross-section considering the acceleration created by residual pressure inside the reactor pressure vessel, and considering the separated head in the process of movement, blocking of aperture executed in the center of the conical part is possible. This may lead to corium accumulation in the conical part area of the guide assembly, and thus to increase of temperature in this area. An increase of temperature may lead to melt-through of the walls of both the conical and cylindrical parts of the guide assembly, following which corium enters outside the corium trap, namely into the structural and serpentine concrete, which on failure generates large quantity of hydrogen and non-condensing gases following which risks of hydrogen explosions and beyond design pressure rise occur in the containment. This may lead to containment failure and escape of beyond-design quantity of radioactive fission products outside the containment limits.

Another problem of the guide assembly is the lack of reallocation (levelling) mechanism of corium jet streams This shall lead to the fact that the impact thermal and mechanical loads are concentrated in the upper and middle area of the cylindrical part. The concentration of impact thermal and mechanical stresses may lead to failure of the guide assembly and corium entry into the structural and serpentine concrete with their subsequent failure and generation of hydrogen and non-condensing gases following which risks of hydrogen explosions and beyond design-basis pressure rise in the containment occur. This may lead to containment failure and escape of beyond-design quantity of radioactive fission products outside the containment limits.

The guide assembly [2] (Corium localizing device, 7th International Research and practical conference “Safety assurance of NPP with VVER”, OKB Gidropress, Podolsk, Russia, May 17-20, 2011) of the corium localizing and cooling system of the nuclear reactor comprising of cylindrical and conical parts with aperture in the center thereof, bearing ribs passing from the central orifice to the boundary of the cylindrical part.

One disadvantage of the guide assembly is the insufficient heat insulation of the walls of conical and cylindrical parts. In the event of quick entry of corium from the reactor pressure vessel on separation of the head with full cross-section considering the acceleration created by residual pressure inside the reactor pressure vessel, and considering the separated head in the process of movement, blocking of aperture executed in the center of the conical part is possible. This may lead to corium accumulation in the conical part area of the guide assembly, and thus to increase of temperature in this area. An increase of temperature may lead to melt-through of the walls of both the conical and cylindrical parts of the guide assembly, following which risks of hydrogen explosions and beyond-design pressure rise in the containment occur. This may lead to containment failure and escape of beyond-design quantity of radioactive fission products outside the containment limits.

Another problem of the guide assembly is the lack of reallocation (levelling) mechanism of corium jet streams This shall lead to the fact that the impact thermal and mechanical loads are concentrated in the upper and middle area of the cylindrical part. The concentration of impact thermal and mechanical stresses may lead to damage of the guide assembly and entry of corium into the structural and serpentine concrete with their subsequent damage and generation of hydrogen and non-condensing gases, following which risks of hydrogen explosions and beyond-design basis pressure rise occur in the containment. This may lead to containment failure and escape of beyond-design quantity of radioactive fission products outside the containment limits

The guide assembly [3, 4, 5] [RF Patent No. 2576516, priority dated 16 Dec. 2014; RF Patent No. 2576517, priority dated 16 Dec. 2014; RF Patent No. 2575878, priority dated 16 Dec. 2014] of the corium localizing and cooling system of the nuclear reactor comprising of the cylindrical and conical parts with aperture in the center thereof, bearing ribs passing from the central aperture to the upper edge of the cylindrical part and dividing the cylindrical and conical parts into sectors, covered with layers of sacrificial and heat-resistant concrete is the closest analog to the claimed invention.

Such a guide assembly is designed for directing corium (melt) after damage or melt-through of reactor to the corium trap, retention of large-sized debris of the reactor internals, fuel assemblies and reactor pressure vessel head against fall of corium into the trap, protection of the cantilever-truss and its communications against damage on corium input from the reactor pressure vessel to the core catcher, guarding the reactor pit against direct contact with corium.

The bearing ribs hold down the reactor pressure vessel casing with corium that does not allow the head in the process of its damage or severe plastic deformation to overlap the cross-sections of the sectors and violate the corium trickling process.

Sacrificial concrete by dissolving in corium provides increase of the cross section in the guide plate sectors when blockades are formed (on corium setting in one or several sectors) that allows not allow overheating and damage of the bearing ribs, i.e. complete blocking of the cross section, and as a consequence damage of the guide plate. Heat-resistant concrete provides structural strength on reduction of the sacrificial concrete thickness. This concrete protects the underlying equipment against corium impact not allowing the corium to melt-through or damage the guide plate.

One disadvantage of the guide assembly is the inability of the two-layer sacrificial concrete to provide increase of the cross-section in the guide plate sectors on simultaneous input of a large volume of metal and oxide melt, for example on separation of reactor pressure vessel head by full cross section or on its sectoral damage. In this case the simultaneous interaction of two types of overheated corium (metallic and oxide) with sacrificial concrete (based on aluminium and ferrous oxides) shall lead to quick release of oxygen, rapid oxidation, aerosol and slag formation with complete overlap of the flow cross section. Taking into consideration that the hot gas-vapor and aerosol interaction products of sacrificial concrete with metal or oxide corium components rise up, and their movement is directed against the corium flow, in a squeezed space between the reactor pressure vessel head and heat-resistant concrete (based on aluminium oxide) hydrodynamic blockage of cellular sacrificial concrete is formed preventing corium movement. On formation of stagnant zone the heat resistant concrete quickly gets overheated and enters into chemical reaction with the corium components increasing the gas-aerosol counter-flow.

One more disadvantage of the guide assembly is the insufficient thermal insulation of the walls of conical and cylindrical part. In the event of quick entry of corium from the reactor pressure vessel on separation of the head with full cross-section considering the acceleration created by residual pressure inside the reactor pressure vessel, and considering the separated head in the process of movement, blocking of aperture executed in the center of the conical part is possible. This may lead to corium accumulation in the conical part area of the guide assembly, and thus to increase of temperature in this area. An increase of temperature may lead to melt-through of the walls of both the conical and cylindrical parts of the guide assembly, following which corium enters outside the corium trap, namely into the structural and serpentine concrete, which on failure generates large quantity of hydrogen and non-condensing gases following which risks of hydrogen explosions and beyond design pressure rise occur in the containment. This may lead to containment failure and escape of beyond-design quantity of radioactive fission products outside the containment limits.

Another problem of the guide assembly is the lack of reallocation (levelling) mechanism of corium jet streams This shall lead to the fact that the impact thermal and mechanical loads are concentrated in the upper and middle area of the cylindrical part. The concentration of impact thermal and mechanical stresses may lead to damage of the guide assembly and entry of corium into the structural and serpentine concrete with their subsequent damage and generation of hydrogen and non-condensing gases, following which risks of hydrogen explosions and beyond-design basis pressure rise occur in the containment. This may lead to containment failure and escape of beyond-design quantity of radioactive fission products outside the containment limits.

### Disclosure of the Invention

The technical result of the claimed invention consists in enhancing the safety of nuclear power plant by enhancing the reliability of the corium localizing and cooling system of the nuclear reactor.

The tasks for resolving thereof the invention is directed consist in providing the following operation conditions of the corium localizing and cooling system of the nuclear reactor:
excluding the blocking of the aperture made in the center of the conical part;
excluding the entry of nuclear reactor corium into the structural and serpentine concretes of the reactor cavity with the subsequent generation of hydrogen and non-condensing gases.

The set tasks are resolved by the fact that the guide assembly (1) of the corium localizing and cooling system of a nuclear reactor, installed under the reactor pressure vessel and resting on the cantilever truss, containing the cylindrical part (2) and conical part (3) with aperture (4) executed in it, bearing ribs (5), located radially relative to the aperture (4) and separating walls of the cylindrical (2) and conical (3) parts for the sectors (7), characterized in that it additionally contains the load-bearing frame, consisting of the external upper thrust ring (8), external lower thrust ring (9), internal central thrust ring (10), external upper shell (11), middle thrust ring (12), separated into sectors by the bearing ribs (5) and having aperture (14) in the upper part, external lower thrust shell (15), foundation (16), bearing stiffeners (17), upper tilted plate (18), connecting the conical head (19), bearing ribs (5) and middle thrust ring (12), lower tilted plate (20), connecting conical head (19), bearing ribs (5), middle thrust ring (12) and external upper thrust ring (11), thermal plate metal shields (23), installed on bearing stiffeners (17) and installed with gap (22) along the internal surface of middle thrust shell (12), and along the upper tilted plate (18), dismountable thermal plate metal shield (13), installed on bearing stiffeners (17) and covering the aperture (4), cooling canal (21), outgoing from the header (6) and passing between the upper and lower tilted plates (18 and 20), and between the middle and external upper thrust rings (12 and 11), connected through the aperture (14) with gap (22) forming a space between the thermal plate metal shield (23) and upper tilted plate (18), in addition, the space (24) limited by the pedestal (16), conical head (19), lower tilted plate (20), part of the upper thrust ring (11), external lower thrust ring (9),external lower thrust shell (11) and middle thrust shell (12), and the space (26) between the upper and lower tilted plates (18 and 20) is filled with concrete or ceramic material (27), leak-tight head (28), connected with the external lower thrust shell (15) and bearing ribs (17).

One feature of the claimed invention is the availability in the Guide assembly (1) of the corium localizing and cooling system of the load bearing frame, consisting of the external upper thrust ring (8), external lower thrust ring (9), internal central thrust ring (10), external upper shell (11), middle thrust ring (12), separated into sectors by bearing ribs (5) and having aperture (14) in the upper part, external lower thrust shell (15), foundation (16), bearing stiffeners (17), upper tilted plate (18), connecting the conical head (19), bearing ribs (5) and middle thrust ring (12), lower tilted plate (20), connecting conical head (19), bearing ribs (5), middle thrust ring (12) and external upper thrust ring (11). In accordance with the claimed invention, the availability of load-bearing frame allows provide retention of large-sized debris of internals and reactor pressure vessel head against fall into the corium trap thus the shell of the corium trap is protected against damages.

One more feature of the claimed invention is the availability in the guide assembly (1) of the thermal plate metal shield (23), installed on bearing stiffeners (17) and installed with gap (22) along the internal surface of the middle thrust shell (12), and along the upper tilted plates (18), of the dismountable thermal plate metal shield (13), installed on the bearing stiffeners (17) and covering the aperture (4). The presence of thermal plate metal shields (23) allows provide gravity trickling to corium filler after damage or melt-through of reactor pressure vessel, protection of the cantilever-truss and its communications against damage during melt movement, excluding direct contact of corium with the reactor cavity equipment and structural concrete, exclusion of direct radiant action on the part of corium on the reactor cavity equipment and fittings of the reactor pressure vessel due to exclusion of the formation of blockades related to blocking of the cross-section by corium, by quick increase of the effective cross-section provided by levelling and melting of the thin elements of thermal plate metal shield (23).

One more distinctive feature of the claimed invention is the availability of the cooling channel (21) coming out of the header (6) and passing between the upper and lower tilted plates (18 and 20), and between the middle and external upper bearing shells (12 and 11), connected through the aperture (14) with gap (22), forming a space between the thermal plate metal shield (23) and middle load bearing shell (12), and between the thermal plate metal shield 923) and upper tilted plate (18) in the guide assembly (1) of the corium localizing and cooling system. The availability of cooling channel (21) provides thermal stabilization of the entire guide assembly (1) during reactor power operation in normal operation conditions.

One more distinctive feature of the claimed invention is that in the guide assembly (1) of the corium localizing and cooling system of the nuclear reactor, the space (24) limited by the base (16), conical head (19), lower tilted plate (20), part of the upper external bearing shell (11), external lower bearing ring (9), external lower bearing shell (15), and the space (25) between the external upper bearing shell (11) and middle bearing shell (12), as well as the space (26) between the upper and lower tilted plates (18 and 20) is filled with concrete or ceramic material (27). The use of concrete and ceramic material (27) in the specified spaces allows provide thermo-mechanical protection of the load-bearing elements of the guide assembly (1) from damage than retention is provided of the reactor pressure vessel and its large fragments on reactor pressure vessel damage, large-sized fragments of the internals against fall into the corium is provided, protection of corium casing against damages on fall of large fragments is provided, protection of corium trap casing against damages on fall of large fragment is provided, protection of the cantilever-truss and its communications against damage during corium movement is provided, exclusion of direct contact of corium with reactor cavity equipment and structural concrete is provided.

One more distinctive feature of the claimed invention is the availability of leak-tight head (28), connected with the external lower bearing shell (15) and knife edges (17) in the guide assembly (1) of the corium localizing and cooling system of the nuclear reactor. The availability of a leak-tight head (28) allows provide water drainage from the head (28) surface, consequently absence of steam explosions at the time of corium input to the filler, and retention of the integrity of filler and structural materials in the process of the entire period of normal operation and during operational occurrences and during design-basis accident.

In aggregate, such a design of the guide assembly allows:
provide gradual intake of corium (melt) after damage or melt-through of the reactor into the corium trap;
provide protection of concrete cavity and dry protection with serpentine concrete against direct contact with corium.

### BRIEF DESCRIPTION OF DRAWINGS

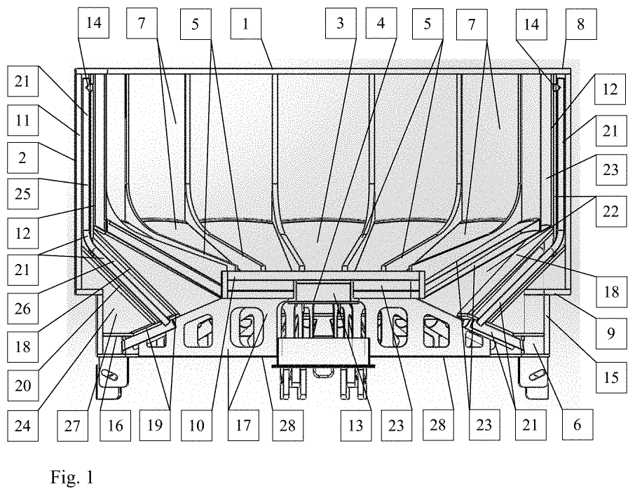

The guide assembly of the corium localizing and cooling system of the nuclear reactor executed in accordance with the claimed invention is shown in FIG. 1.

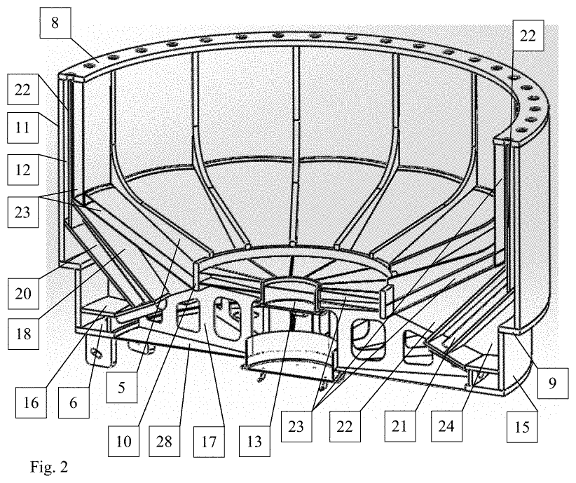

The sectional view of the guide assembly of the corium localizing and cooling system of the nuclear reactor, executed in accordance with the claimed invention is shown in FIG. 2.

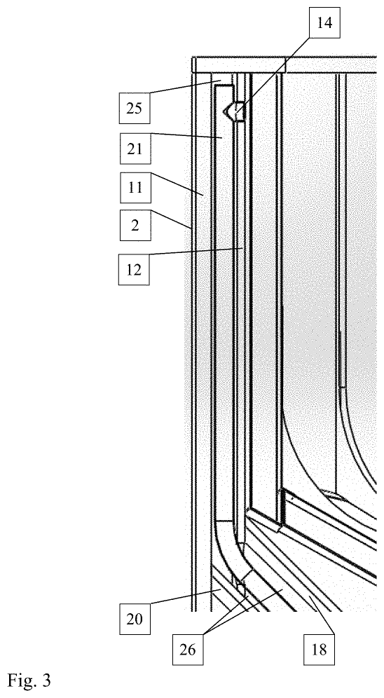

The guide assembly fragment of the corium localizing and cooling system of the nuclear reactor, executed in accordance with the claimed invention is shown in FIG. 3.

### EMBODIMENTS OF THE INVENTION

As shown in FIG. 1, the guide assembly (1) of the corium localizing and cooling system of the nuclear reactor installed below the reactor pressure vessel and resting upon the cantilever truss contains the cylindrical part (2) and conical part (3). An aperture (4) is made in the base of the conical part (3). Bearing ribs (5) pass along the conical and cylindrical parts (2 and 3) located radially with respect to the aperture (4). The bearing ribs (5) divide the walls of the cylindrical (2) and conical (3) parts into sectors (7). The guide assembly (1) contains the load-bearing frame, which consists of the following basic (load bearing) elements: external upper load-bearing ring (8), external lower load-bearing ring (9), internal central load-bearing ring (10), external upper load-bearing shell (11), middle load-bearing shell (12). Middle load-bearing shell (11) is divided into sectors by the bearing ribs (5) similar to the wall of the cylindrical part (2). The bearing frame is also composed of the external lower load bearing shell (15), base (16), knife edges (17), upper tilted plate (18). The upper tilted plate (18) connects the conical head (19), bearing ribs (5) and middle load-bearing shell (12). The lower tilted plate (20) connects the conical head (19), bearing ribs (5), middle load-bearing shell (12) and external upper load-bearing shell (11).

Apart from the load-bearing elements, the following thermal elements are used as part of the guide assembly (1): thermal plate metal shields (23), dismountable thermal plate metal shield (13). The thermal plate metal shields (23) are installed on the knife edges (17), and with gap (22) along the internal surface of the middle load bearing shell (12) and along the upper tilted plate (18). The dismountable thermal plate metal shield (13) is installed on the knife edges (17) and closes the aperture (4).

The cooling channel (21) passes between the upper and lower tilted plates (18 and 20) and between the middle and external upper load-bearing shells (12 and 11).

The cooling channel (21) exits from the header (6) and connects through the aperture (14) with gap (22) forming the space between the thermal plate metal shield (23) and middle load bearing shell (12), as well as between the thermal plate metal shield (23) and upper tilted plate (18).

The space (24) limited by the base (16), conical head (19), lower inclined plate (20), part of the upper external load-bearing shell (11), external lower bearing ring (9), external lower load-bearing shell (15) and space (25) between the external upper load-bearing shell (11) and middle load-bearing shell (12), as well as the space (26) between the upper and lower tilted plates (18 and 20) is filled with concrete or ceramic material (27).

A leak-tight head (28) is welded below to the external lower load-bearing shell (15) and knife edges (17).

The claimed guide assembly functions as follows.

As shown in FIGS. 1-3, the guide assembly (1) installed on the cantilever truss below the reactor pressure vessel head, in accordance with the gist of the claimed invention, performs the thermal barrier functions between the reactor pressure vessel and the reactor cavity equipment in its lower part, and between the reactor pressure vessel head and corium trap located below the guide assembly (1). The availability of thermal barrier during normal operation allows provide thermal insulation of the reactor pressure vessel head, and during severe accident at the time of reactor pressure vessel damage by corium provide conditions for diagnosis of the start of melt entry into the trap.

Heat insulation consisting of plate metal thermal shields (23), executed in the form of packets assembled from dimple and non-dimple thin stainless steel sheets is installed on the guide plate for providing thermal insulation of the reactor pressure vessel head during normal operation. Such packets are installed on the walls (6) of the cylindrical and conical parts (2 and 3), and on the inner surface of the middle load-bearing shell (12) and upper tilted plate (18) using the fasteners providing thermal displacements of heat insulating packets and guide plate frame with respect to each other during normal operation, operational occurrence and design-basis accident.

The dismountable thermal plate metal shield (13) is installed directly below the reactor pressure vessel head pole that provides if required access to the external surface of the reactor pressure vessel. An hatch with displacing inset is executed for access to the dismountable thermal plate metal shied (13) in the lower part of the guide assembly (1) on the service platform side. Such a design allows exclude water accumulation in the hatch during operational occurrence, during design-basis and beyond design-basis accidents.

The space between the load-bearing elements (5, 8, 11, 9, 15, 16, 19, 18, 12) of the guide assembly is filled with heat-resistant concrete for providing thermal insulation of structural concrete and cantilever truss during beyond design-basis accident. The load-bearing elements (5, 8, 11, 9, 15, 10) and concrete and ceramic material (27) form according to their function the guide assembly in the form of a funnel, providing coverage of the lower part of the reactor pressure vessel above the connection plane of the head with the cylindrical part (2). In the process of corium exit, the guide assembly (1) can be subjected both to a relatively slow loading under plastic deformations of the reactor pressure vessel, and to impact loading when the head of the reactor pressure vessel is torn off due to the residual pressure. These loads are taken up by the guide assembly, formed by the load-bearing elements (5, 8, 11, 9, 15, 10) and concrete and ceramic material (27). Such a design shall provide:
free-flow drainage to the corium filler after damage or melt-through of reactor pressure vessel;
retention of large-sized debris of internals and head of the reactor pressure vessel against fall into the corium trap;
protection of corium trap casing against damages on fall of large fragments;
protection of the cantilever truss and its communications against damage on corium movement.
excluding direct contact of corium with the reactor cavity equipment and construction concrete;
exclusion of direct radiant impact on the part of the corium on reactor cavity equipment and reactor pressure vessel fittings. The layers of sacrificial material (concrete or ceramic) are located under the tilted surfaces of the guide assembly—under the upper and lower tilted plates (18 and 20). directly below the upper tilted plate (18) is the sacrificial layer prepared for example based on aluminium and ferrous oxides, and under the lower tilted plate (20) is the thermally durable heat-proof layer, made for example based on aluminium oxide.

The sacrificial material located under the upper tilted plate (18), by melting in the corium ensures increase of the cross-section in the guide assembly (1) sectors, if the increase of the effective cross-section provided by the flattening and melting of the thin elements of the plate metal shied (23) was not sufficient for example on outflow of the melt from the reactor pressure vessel with large flow exceeding the cross-section throughput capacity of the guide assembly (1) or on outflow of corium with core debris covering the cross-section and preventing free outflow of corium. The dissolving of the sacrificial material allows to not allow overheat and damage of bearing ribs (5). The complete blocking of the cross-section is possible on damage of the bearing ribs (5), and sectoral damage of the guide assembly (1) as a consequence of this.

The thermal-resistant heat-proof layer located below the lower tilted plate (20) provides strength and stability of the structure on reduction of the thickness of sacrificial material located between the upper and lower tilted plates (18 and 20). Thermal resistant concrete protects the underlying equipment against the corium impact, by not allowing the corium to sectoral through melt-through or damage the guide assembly.

The guide assembly (1) on reactor pressure vessel damage takes on itself the dynamic loads occurring:
on lateral outflow of corium under the action of residual pressure in the reactor pressure vessel;
on increase of the lateral cavity cross-section in the reactor pressure vessel and change of its profile in the process of corium outflow;
on detachment of reactor pressure vessel head parts following plastic deformation under the action of thermal and mechanical loads and residual pressure;
on detachment of the reactor pressure vessel head parts following impulse pressure rise inside the pressure vessel (on flooding the corium with water) and their shock diffusion about the guide vanes;
during external effects and auto shocks in the process of beyond design-basis accident propagation.

Before the start of corium inflow the filler present in the trap casing is tightly closed by the head (28) of the guide assembly (1) that provides:
water drainage from the head surface (28) and as a consequence of this no steam explosions at the time of corium inflow to the accumulator.
retention of integrity of the accumulator and structural materials in the process of the total period of normal operation, and on abnormal operation and during design-basis accident.

The following is performed for providing unconstrained inflow of corium:
leak-tight head (28) is executed in the form of an easily damageable membrane;
thermal plate metal shields (13 and 23) are executed with easily damageable high-temperature corium so as to not prevent its displacement. On melting of the thermal insulation the cross-section for the tricking of corium along the surface of the guide assembly increases several times. Various degree of increase of the cross-section is provided for the vertical and tilted thermal plate metal shields (23) that is related to different geometry of the channels formed by the vertical bearing fins;
An aperture (4) is made in the central part of the guide assembly for corium passage, sizes thereof is limited by the scatter of solid and liquid fragments of the core in the process of its outflow from the reactor pressure vessel.

Thus, the thermal plate metal shields (23) and sacrificial material installed below the upper and lower tilted plates (18 and 20), used as guide assembly (1) of the core localizing and cooling system of the nuclear reactor perform anti-impact, channel forming and protection functions.

The plate metallic heat shields (23) provide initial damping of the impact load on the part of the separated sectors of the damaged head considering the acceleration created by residual pressure inside the reactor pressure vessel. Moreover, the crushed plate metal heat shields (23) provide the initial protection of the guide assembly (1) and against impact action of the corium jet at small residual pressure in the reactor pressure vessel.

On strong dynamic response on the part of the separated sectors of the damaged head of the reactor pressure vessel, the concrete or ceramic materials (27) forming the protective layer around the critically important load-bearing elements (5, 11, 15, 9) of the guide assembly (10) takes the impact load, moreover the bearing fins (5) may be partially melted, especially this concerns the tilted part protected by layers of sacrificial material under the upper and lower tilted plates (18 and 20).

Together with the load-bearing elements (5, 8, 11, 9, 15, 18, 20, 12) of the guide assembly (1) the concrete or ceramic material (27) creates impenetrable barriers for the flying objects and corium jet.

Thus, the thermal plate metal shield (23) and concrete or ceramic material (27) forming the protective layers of load-bearing elements (5, 9, 11, 12, 15) of the guide assembly (1) ensure breaking and blocking of large fragments of reactor pressure vessel and its internals, at the same time providing sequential input of corium, fragments of internals and head of the nuclear reactor pressure vessel in the corium trap.

The removable thermal plate metal shields (23) provide increase of the cross- section for displacement of corium in each radial vertical and tilted sectors and in azimuth direction on horizontal flow of corium.

During severe thermo-mechanical impact on the part of corium outflowing from the reactor pressure vessel the cross-section increases in the guide assembly (1) for displacement of corium by thermo-chemical interaction of the concrete or ceramic material (27) with corium, besides the chemical activity and thermo-mechanical impact on the load-bearing frame of the guide assembly (1) are reduced that retention of its integrity.

Thus, the thermal plate metal shields (23) and concrete or ceramic material (27) forming the protective layers of the load-bearing elements (5, 9, 11, 12, 15) of the guide assembly (1) provides protection of the structural and serpentine concretes of the reactor cavity against interaction with corium.

The concrete or ceramic material (27) forming the protective layers around the critically important load-bearing elements (5,11, 15, 9) of the guide assembly (1) create thermal and chemical barriers preventing the surface and structural damage of the load-bearing elements (5, 8, 11, 9, 15, 18, 20, 12) of the guide assembly (1) on thermal and thermo-mechanical impacts on the part of corium jet, for which purpose the thermal resistance of concrete or ceramic material (27) is selected different in different directions of corium flow that provides earlier damage of the sacrificial material under the upper tilted plate (18) located close to the reactor pressure vessel than is achieved by quicker escape of corium and reduction of thermo-chemical and thermo-mechanical impacts on the critically important load-bearing elements (5, 6, 9, 7, 11, 14, 10) of the guide assembly (1).

Thus, the concrete or ceramic material (27) forming the protective layers of the load-bearing elements (5, 6, 9, 7, 11, 14, 10) of the guide assembly (1) provides their strength on lateral melt-through of the reactor pressure vessel and as a consequence protection of the structural and serpentine concretes of the reactor cavity against interaction with corium.

The use of guide assembly (1) having load-bearing frame equipped additionally with thermal elements allowed provide gradual input of corium (melt) after damage or melt-through of the reactor pressure vessel, retention of large-sized fragments of the internals, fuel assemblies and head of the reactor pressure vessel against fall into the corium trap, protection of the cantilever truss and its communications against damage on corium input from the reactor pressure vessel to the corium trap, without blocking of the central aperture made in the conical part, preservation of the concrete cavity and dry protection with serpentine concrete against direct contact with corium.

Sources of information:

1. RF patent No. 2253914, IPC G21C 9/016, priority dated 18 Aug. 2003

2. Corium localizing device, 7th International Research and Training Conference “Safety assurance of NPP with VVER”, OKB Gidropress, Podolsk, Russia, May 17-20, 2011.

3. RF patent No. 2576516, IPC G21C 9/016, priority dated 16 Dec. 2014;

4. RF patent No. 2576517, IPC G21C 9/016, priority dated 16 Dec. 2014;

5. RF patent No. 2575878, IPC G21C 9/016, priority dated 16 Dec. 2014.

1. A guide assembly (1) of a corium localizing and cooling system of a nuclear reactor, installed under the reactor pressure vessel and resting on the cantilever truss, containing the cylindrical part (2) and conical part (3) with aperture (4) executed in it, bearing ribs (5), located radially relative to the aperture (4) and separating walls of the cylindrical (2) and conical (3) parts for the sectors (7), characterized in that it additionally contains the load-bearing frame, consisting of the external upper thrust ring (8), external lower thrust ring (9), internal central thrust ring (10), external upper thrust shell (11), middle thrust shell (12), separated into sectors by bearing ribs (5) and having aperture (14) in the upper part, external lower thrust shell (15), base (16), bearing stiffeners (17), upper tilted plate (18), connecting the conical head (19), bearing ribs (5) and middle thrust shell (12), lower tilted plate (20), connecting conical head (19), bearing ribs (5), middle thrust shell (12) and external upper thrust shell (11), thermal plate metal shields (23), installed on bearing stiffeners (17) and installed with gap (22) along the internal surface of middle thrust shell (12), and along the upper tilted plate (18), dismountable thermal plate metal shield (13), installed on bearing stiffeners (17) and covering the aperture (4), cooling channel (21), outgoing from the header (6) and passing between the upper and lower tilted plates (18 and 20), and between the middle and external upper thrust shells (12 and 11), connected through the aperture (14) with gap (22) forming a space between the thermal plate metal shield (23) and middle thrust shell (12), as well as between the thermal plate metal shield (23) and upper tilted plate (18), in addition, the space (24) limited by the base (16), conical head (19), lower tilted plate (20), part of the upper thrust shell (11), external lower thrust ring (9), external lower thrust shell (15), as well as the space (25) between the external lower thrust shell (11) and middle thrust shell (12), and the space (26) between the upper and lower tilted plates (18 and 20) is filled with concrete or ceramic material (27), leak-tight head (28), connected with the external lower thrust shell (15) and bearing ribs (17).
